(19) United States
(12) Patent Application Publication
(10) Pub. No.: US 2008/0093950 A1
(43) Pub. Date: Apr. 24, 2008

(54) Polyphase Claw-Pole Machines With a Segmented Magnetic Circuit

(75) Inventors: Jerome Cros, Quebec (CA); Philippe Viarouge, Quebec (CA)

Correspondence Address: FITZPATRICK CELLA HARPER & SCINTO, 30 ROCKEFELLER PLAZA, NEW YORK, NY, 10112, US

(73) Assignee: ELECTROTECHNOLOGIES SELEM. INC, Quebec, QC (CA)

(21) Appl. No.: 10/578,357

(22) PCT Filed: Dec. 9, 2004
(86) PCT No.: PCT/CA04/02097

§ 371 Date: Aug. 31, 2007

Related U.S. Application Data
(60) Provisional application No. 60/528,047, filed on Dec. 9, 2003.

(51) Int. Cl. H02K 1/06; H02K 15/02; H02K 9/00

(52) U.S. Cl. 310/257; 310/44; 310/52; 310/217; 310/42

(57) ABSTRACT

A polyphase claw-pole armature for an electrical machine is made with several identical segments regularly distributed along the direction of motion and spaced by a magnetic air gap. The number of segments is equal or a multiple of the number of winding phases. Each segment includes a magnetic circuit with a plurality of claws arranged in a plurality of rows, with the base of each claw connected to a common yoke. One or a plurality of non-interlaced coils are included inside each segment, with the coils being wound around the bases of corresponding claws.

### BACKGROUND OF THE INVENTION

The invention relates to electric machinery. In particular, this invention relates to the design of claw pole structures with a segmented magnetic circuit for polyphase electrical machinery.

Electric machinery makes use of a changing magnetic field to produce either an electrical current or a mechanical force. In the case of electric machinery adapted to produce an electrical current, a magnetic field is passed over a wire coil, which induces the desired electrical current in the wire coil. In the case of electrical machinery used to produce a mechanical force, an electric current is passed through a wire coil, which causes the coil to be attracted to (or repelled by) an adjacent magnetic field, thereby yielding the desired force.

The foregoing principles are commonly implemented in rotating electrical machinery. For example, in an electric generator or alternator, a rotating element, or rotor, is passed through the magnetic field produced at intervals by a stator, which has a number of poles arranged around the direction of rotation to provide the magnetic field (which can be generated electromagnetically). An electrical motor can have a similar structure; the only difference in principle being that electric current is provided to the rotor coils, rather than being (in the case of a generator or alternator) generated by the rotor coils.

The geometrical design and composition of the stator poles affects the efficiency of operation, as well as the size, shape, and weight of the electrical machine. A claw-type structure is frequently used for the rotor poles of electrical machines having a single centralized winding or coil. In the case of alternator rotors, the coil is fed by a DC current. In other applications, such as in asynchronous motors, stepper motors, brushless permanent magnet motors, and reluctance motors, the stator coil is fed either by an A.C. current or by impulsions.

It is well known that claw-pole structures present several advantages. An example of an electrical machine using a high number of claw poles is the “canned motors” used in timers or car alternators, which use a claw pole rotor (U.S. Pat. No. 3,271,606 and U.S. Pat. No. 3,714,484). However, this configuration is generally applied to single-phase machines, which use only one coil that is embedded in a magnetic circuit made of two parts equipped with claws. This kind of arrangement is called a “centralized winding”. The plane defined by the coil is perpendicular to the surface of the air gap between the stator and the rotor.

In the case of the inductor of a car alternator, the coil is fed by a DC current. Other applications, such as the stators of asynchronous motors (U.S. Pat. No. 3,383,534), stepper motors (U.S. Pat. No. 5,331,237), and brushless permanent magnet motors (U.S. Pat. No. 5,854,526), illustrate the use of claw-pole structures where the coil is fed either by an AC current or by current pulses.

The implementation of a polyphase structure with a claw-pole armature is usually more difficult. It is necessary to stack several identical single-phase structures placed on the stator or on the rotor, following a direction perpendicular to the direction of motion. This arrangement provides a polyphase claw-pole machine with a centralized winding. This winding may be easier to realize than other winding configurations because the total number of coils is generally equal to the number of phases of the motor. It is necessary to separate each single-phase structure by air gaps to avoid magnetic short circuits and performance degradations. However, in the case of low-power motors, such as stepper motors, one can often tolerate this kind of degradation of performance by directly juxtaposing several single-phase structures without adding air gaps between the structures (U.S. Pat. No. 6,259,176 and U.S. Pat. No. 6,031,304). U.S. Pat. No. 5,854,526 illustrates another arrangement of the coils for a three-phase motor with a claw-type structure. Three coils are placed in the same plan and their axes are parallel to the surface of the air gap between the stator and the rotor. As in the case of the preceding structures, the plan defined by the coils is perpendicular to the air gap surface. However, these structures do not solve the problems of magnetic short circuits and should only be used in applications with a very small power.

A new kind of polyphase claw pole structure has been described in a conference paper “New structures of polyphase claw pole machines” (J. Cros and P. Viarouge—Annual Meeting of IEEE-Industrial Applications Society, Pittsburgh, October 2002). As in the case of previous claw-pole structures, the magnetic circuit surrounds the coils and it can be divided in several sections to facilitate its assembly. The arrangement of the coils is different when compared to previous claw-pole structures with a single coil or polyphase structures as described in U.S. Pat. No. 5,854,526.

FIGS. 1A and 1B show several views of a prior-art polyphase claw-pole armature 10. This armature has a magnetic circuit 105 (FIG. 1A) that is formed from a magnetic material. In this example, the magnetic circuit 105 has been divided in two different annuli 110, 120 along the direction of motion. There are several projecting fingers, or claws 112, 114, 116, 122, 124, 126 extending radially, inwardly to front along the air gap next to the surface of the rotor (not shown). Three coils 132, 134, 136 are wound around the base of the claws 112, 114, 116 and are surrounded by the claws 122, 124, 126 of the second part 120 of the magnetic circuit. This kind of coils arrangement is called a “centralied-concentrated winding.”

FIGS. 2A and 2B show an assembly of two prior-art polyphase claw pole structures presented in FIGS. 1A and 1B, which are stacked together. However, in this case, the magnetic circuit 200 of this armature has been divided in three sections 210, 220, 230 along the direction of motion. The coils 242, 244 and 246 are mounted on the claws 222, 224, 226 of the central magnetic circuit section 220. The two lateral magnetic circuit sections 210 and 230 are identical. With this magnetic circuit arrangement, the central-concentrated winding is enclosed inside the armature magnetic circuit (FIG. 2A).

In such prior-art polyphase claw pole structures described in FIGS. 1A, 1B and FIGS. 2A, 2B), the magnetic circuit is equipped with several rows of claws which can be mounted on separated sections of magnetic circuit. These claws are facing the air gap between the stator and the rotor and are extending along the rotor revolution axis. As presented in FIG. 1B, some claws like the claws 112, 114, 115 can be widened from both sides of the claw base to form claw tips that mechanically secure the winding. The claws (or fingers) of two adjacent rows can be interlocked (or interspaced) to cover a larger surface of the air gap between the stator and rotor. In these prior-art structures, the bases of all the claws are always connected to a common magnetic yoke. The coils are not interlocked and are regularly distributed around the cylindrical air-gap surface between the stator and rotor in the case of a rotational motion, or along the planar air-gap surface between the stator and rotor in the case of a linear motion. The axes of these coils are perpendicular to the surface of the air-gap between the stator and the rotor: This arrangement also means that the plane defined by the coils is parallel to the air-gap surface between the stator and rotor. With this structure, the magnetic flux produced by the rotor poles circulates alternatively in the three directions in the core and in the claws without a DC component.

The segmentation of the magnetic circuit has been proposed for several kinds of laminated motor structures where there is a 2D magnetic flux is circulation into a plane and where a winding supplied with a direct current (U.S. Pat. No. 4,754,207, U.S. Pat. No. 5,545,936, U.S. Pat. No. 6,384,496, and U.S. Pat. No. 6,492,756). Such a division simplifies the manufacturing process and provides flexible motor configurations. Each segment or sector of magnetic circuit can be independently and uniformly manufactured and wound (U.S. Pat. No. 6,384,496). It provides also ready accessibility to various structural components for replacement of parts with a minimum of inconvenience (U.S. Pat. No. 6,492,756).

Miller et al. (U.S. Pat. No. 6,531,799) have developed a hybrid electric machine with an inductor excitation system made with permanent magnets and several electromagnets. This arrangement permits to control the excitation magnetic field with the direct current of the electromagnets. Liang et al. (U.S. Pat. No. 6,359,366) have also proposed another arrangement with permanent magnets inserted between the claws in the rotor of a Lundell alternator.

The use of laminated materials has constrained the armature geometries of polyphase electrical machines. Typically, the magnetic circuit is constructed by stacking identical laminations one on top of the other, which are electrically isolated from each other to avoid the circulation of eddy currents. These armature geometries are invariant along the axis of rotation.

In the case of an AC claw-pole armature, it is preferable to realize the core with an isotropic composite magnetic material to minimize the eddy current losses (U.S. Pat. No. 3,383,534 and U.S. Pat. No. 5,331,237). One can also use a hybrid assembly of magnetic sheets, or laminations, and other parts made from iron-powder materials, produced by powder metallurgy methods (U.S. Pat. No. 6,320,294, U.S. Pat. No. 6,201,324).

Heat dissipation is also a critical problem in the machine structures that use laminated materials, because the heat transfer is much less efficient in the direction perpendicular to the plan of the laminations. Cooling systems, such as an external extruded aluminium yoke equipped with cooling fins, are usually press-fit around the lamination stack to try to improve heat transfer to the ambient atmosphere, but the efficiency of such cooling systems is limited by their poor thermal contact with the laminations. All these problems explain the relatively high number of heterogeneous parts which are necessary in a conventional electrical machine to perform the electromagnetic, mechanical and thermal functions, and which increase its material and assembly cost: windings, laminations, flanges, bearing housing supports, fixing screws and rods, external yoke, aluminium fins, etc.

It is possible to make parts of an electrical machine with an isotropic magnetic material, such as soft magnetic composites made of iron powder. Cooling fins made of the same magnetic material can be also integrated in the magnetic circuit parts. (CA Pat. 2282636-12/1999).

### SUMMARY OF THE INVENTION

This invention concerns different structures of polyphase claw-pole armatures for an electrical machine made with a segmented magnetic circuit and their associated assembly methods. These structures can be used for the design and construction of stator armature of polyphase electrical machines (motors and alternators), fed by AC or pulse currents such as synchronous and permanent magnet machines, stepper motors, asynchronous machines and reluctance machines, covering a large power range. These polyphase structures can also be used for the design of the rotor armatures of DC machines (motors or generators).

In these machines, the air-gap surface is either planar, in the case of linear motion, or cylindrical, in the case of rotational movement. To simplify the following description, we will only consider examples of the armature magnetic circuits of cylindrical machine. The figures present structures with a cylindrical air-gap surface only and with a rotational motion around the axis of the air-gap surface. However, the same structures can also be used for the rotor of other kinds of electrical machines, like DC machines. One can also have planar air-gap surfaces with either a linear motion or a rotational motion around an axis perpendicular to the air gap surface.

As in the case of prior-art claw-pole structures, the magnetic circuit surrounds the coils and it can be divided in several sections, following the direction of motion, to facilitate its assembly with the coils. This magnetic circuit is equipped with several rows of claws, facing the air gap between the stator and the rotor. Generally, the claws (or fingers) of two adjacent rows are interlocked (or interspaced) to cover a larger surface of the air-gap. In this case, the axial length of each claw is higher than one half of the slot width between 2 rows of claws. However, it is also possible to avoid the interlocking of the claws to minimize the leakage flux between claws and the inductance value of the winding. In this case, the axial length of each claw is lower than one half of the slot width between 2 rows of claws.

The specific claw-pole structures considered in this present invention have a centralized-concentrated winding. The coils are wound around the bases of certain claws and are not interlocked. There are regularly distributed around the cylindrical air-gap surface between the stator and rotor in the case of a rotational motion, or along the planar air-gap surface between the stator and rotor in the case of a linear motion. The base of a claw is a part of the magnetic circuit that is perpendicular to the surface of the air gap between the stator and rotor, like a tooth in a conventional slotted armature. The axes of the coils are always perpendicular to the surface of the air gap between the stator and rotor: this arrangement also means that the plane defined by the coils is parallel to the air-gap surface between the stator and rotor. In these structures, the magnetic flux produced by the inductor poles circulates alternatively in the three directions in the core and in the claws without a DC component.

The present invention differs from previous efforts by a use of several identical segments of magnetic circuits for the realisation of a polyphase claw-pole armature for an electrical machine. These segments are uniformly distributed around the cylindrical air-gap surface between the stator and rotor in the case of a rotational motion, or along the planar air-gap surface between the stator and rotor in the case of a linear motion, but they are not connected to a common magnetic yoke. Indeed, these segments are always separated by a magnetic air-gap; this air-gap surface between two adjacent segments is in a plane perpendicular to the cylindrical air-gap surface between the stator and rotor in the case of a rotational motion, or perpendicular to the planar air-gap surface between the stator and rotor in the case of a linear motion.

The segmentation of the armature facilitates the realization and the production of the different parts of the magnetic circuit. This advantage becomes much more important when these parts are molded or pressed by using powder metallurgy production techniques: in this case, it is easy to respect the pressing constraints and to minimize the size of the tooling and the size of the press, even for electrical machines presenting a large diameter. There is also an important advantage in the production and assembly of the coils, which can be realized apart and inserted during the final assembly steps of the armature.

The maintenance of a segmented armature is also improved because it is easy to replace one segment by another and to minimize the time of intervention.

When the segmentation is correctly applied on these polyphase claw-pole structures with concentrated-centralized winding, as described in this invention, it also is possible to improve the performance. Generally, the no-load flux induced in the armature is increased by approximately 15% when compared to a similar armature using a single non-segmented magnetic circuit. The armature winding synchronous or cyclic inductance can be also minimized if each phase winding is mounted in different armature segments. In this case, there is no magnetic coupling between the different phase windings and the mutual inductance between the different phase windings is minimized. Consequently, the power factor of the machine is improved in comparison to a non-segmented structure.

Generally, the armature segmentation produces an increase of the cogging torque in the case of permanent magnet machines. However, there are several well known available methods which can be used to minimize this cogging torque: suitable choice of the number of claws versus the number of rotor poles, use of different magnets rows on the rotor with a suitable angular shifting, suitable adaptation of the claw widths and shapes and rotor shape.

When the armature segments are magnetically and electrically isolated, the machine reliability is improved: for example the propagation of a phase short-circuit fault is reduced. Because the magnetic coupling between phases is minimized with armature segmentation, the machine fault tolerance is improved in the case of an open phase, a short-circuited phase or an electronic converter fault operation.

In the present invention, the armature segments must be separated by an air-gap. Consequently, the armature segments cannot be assembled by mechanical parts where the magnetic flux can easily circulate. One can use mechanical parts made of non-magnetic materials, or mechanical parts made of materials that can be easily magnetically saturated. There must be only one phase winding made of one or several coils in each armature segment. It is also possible to connect the windings of different segments in series or in parallel to realize a complete phase armature winding.

In the present invention, a complete machine armature is formed with several segments which are assembled and mechanically fixed on a non magnetic yoke and/or on non magnetic flanges. An example of such a complete segmented cylindrical armature 30 according to the present invention is shown in FIGS. 3A and 3B. This armature 30 is composed of three identical segments 320, 330, 340 that are assembled and correctly positioned by use of the two annular flanges 310, 350. These flanges can be fixed on the lateral parts of the magnetic circuit of each segment. It also is possible to use a cylindrical yoke fixed to the upper part of each armature segment to realize the assembly of the three armature segments, as shown in FIGS. 5A and 5B with the yoke 510. The cylindrical yoke 510 and the flanges 310, 350 can be made with a material which preferably is non magnetic (aluminum, stainless steel, plastic, etc.). It is also possible to use a massive magnetic material to make these parts, if their cross section is small enough to obtain a magnetic saturation of the material. With such saturated parts, the magnetic flux leakage between two adjacent armature segments is minimized.

An armature segment, according to this invention, has a magnetic circuit divided in two or three parts, following the direction of motion. The claws on each magnetic part of this armature segment do not necessarily have the same dimensions. The shape of the claws can be adapted to adjust the harmonic content of the electromotive force and to control the amplitude of the cogging torque. Different shapes of the claw part facing the air gap between stator and rotor can also be adopted, according to the specifications and the constraints of the machine application. The most common shapes are rectangular, triangular, or trapezoidal. One can also skew the claws tangentially to the air-gap surface, in the direction of motion, to reduce the cogging torque by using the same skewing method used in conventional machines. The thickness of the air gap between the rotor and the stator can vary along the surface of the same claw. With such an approach, the spatial flux density distribution in the air gap and the flux density distribution in different parts of the claw can be precisely adapted.

An armature segment, according to this invention, has a magnetic circuit equipped with claws and one or several coils are wound around the bases of some of these claws. The base of each claw is the portion of the magnetic circuit that connects the claw to the yoke. Generally, the cross section of a claw base has a rectangular shape. Nevertheless, it is preferable to round the corners to simplify and improve the winding realization and/or insertion. In some cases, one can also use oval or circular shapes to minimize the size of the coils.

An armature segment, according to this invention, may have several claws connected to a single claw base. This arrangement provides a magnetic flux concentration in a single coil wound around this claw base and a minimization of the size of the coils.

The magnetic circuit of an armature segment, according to this invention, is preferably made of an isotropic and low conductive magnetic material like a soft magnetic composite material made of iron powder. In this case, the magnetic parts are formed by pressing, molding, or machining. It is also possible to realize the magnetic circuit of each segment by assembling several parts of different magnetic materials like conventional laminated materials and soft magnetic composite material. In special cases, where the coil assembly on the core is difficult, it is possible to split the magnetic circuit in several assembled parts to facilitate the mounting of the coils. Subsequently, the mechanical assembly can be carried out by gluing, screwing, or pressing these individual parts together.

An armature segment, according to this invention, includes one or several coils that are series or parallel connected and which belong to the same phase winding. Consequently, there is only one phase winding phase per segment. However, it is possible to connect the windings of several segments in parallel or in series to realize a complete machine phase winding.

An armature segment, according to this invention, can have a magnetic circuit divided in several parts for a simplification of the assembly of the coils on the magnetic circuit.

Generally; the claw-pole segmented armature of the present invention is used in association with another mobile machine part separated from this armature by an air-gap surface. This other machine part is called “a rotor” in the case of a cylindrical machine. It generates magnetic poles, alternately magnetized North-South. Consequently, the segmented armature of this invention can be associated with conventional rotors of synchronous machines, permanent magnet machines, induction machines, variable reluctance machines, stepping motors, and hybrid stepping motors. However, specific arrangements of rotor structures can be advantageously associated to a segmented armature as illustrated by FIGS. 7 to 11.

The rotor can be split in several parts following the direction of the motion (FIGS. 7, 8, and 9). With such an arrangement, it is possible to position correctly each inductor yoke, in regard to the claws and distribute the same amount of magnetic flux through claws placed in different rows. In this case, one can use a same cross section of claws to obtain a same induction level in the magnetic circuit.

FIGS. 10 and 11 show other arrangements for the realization of hybrid rotor structures made from the association of two different types of structures stacked along the rotor axis.

When it is necessary to design a line of different motors to cover a specific power range, it is possible to use a same single armature segment to optimize the production process of motors. In this case, several identical segments can be stacked together along the axis of rotation, without any axial separation, with an axial air-gap. Such an association of two identical segments for the realization of a segmented claw-pole armature, according to this invention, doubles the power of the initial machine. This assembly is very simple and it minimizes the number of single different parts to produce. The mechanical fixation is realized by the lateral parts of the segmented armatures and the windings can be connected in series or in parallel. One can then use a single inductor structure to cover the whole axial length of the motor, but it is also possible to use several stacked rotor yokes or several rotor yokes separated by axial air gaps. In addition, one can also use a slight angular displacement between each armature segment in the direction of rotation. The oscillations of the cogging torque can thereby be minimized, and the harmonic content of the electromotive forces can be filtered out.

It is also easy to equip the armature segment of this invention with a cooling system, with efficient natural or forced air convection or water circulation. This system can be totally integrated in the magnetic circuit parts, with or without using another kind of material. For example, the cooling fins and armature yoke can be compacted in a single pressing operation, with the cooling fins distributed around the outer surface of the segment yoke. If these fins are made with a composite magnetic material and oriented along the axial length of the machine, the magnetic flux can also circulate in them: they are “magnetically active.” With such an arrangement the total size and weight of the motor is still minimized and the torque to weight ratio of the machine is increased. A fluid circulation cooling system can be also easily integrated in such structures. Each segment can be easily insulated for the circulation of the cooling fluid. It is also possible to install pipes or ducts for the circulation of the cooling fluid, which can be non-magnetic, and which can be directly in contact with the winding coils and arranged in a plan parallel to the rows of claws. These pipes can be secured mechanically by the claws of the lateral parts. Channels for the circulation of the cooling fluid can be also directly realized in the yokes of the magnetic circuit made of soft magnetic material.

### BRIEF DESCRIPTION OF THE DRAWINGS

FIGS. 1A and 1B respectively depict assembled and exploded views of a prior-art, polyphase claw-pole structure wherein the armature magnetic circuit is divided into two parts along the direction of motion and three coils are mounted on the claw base of one part.

FIGS. 2A and 2B respectively depict assembled and exploded views of an alternative assembly of the structure in FIGS. 1A and 1B, wherein the armature magnetic circuit is divided into three sections along the direction of motion and wherein three coils are mounted on the claw base of central section and the two lateral sections of the magnetic circuit are identical.

FIGS. 3A and 3B respectively depict front and assembled views of a polyphase segmented claw pole structure wherein the mechanically assembly of the segmented armature is realized with two annuli flanges and wherein the armature is made with three identical components (segments) based on the present invention which are regularly spaced along the direction of motion and which are magnetically isolated from each other.

FIG. 4A and 4B respectively depict assembled and exploded views of one armature segment based on the present invention wherein the armature magnetic circuit is divided into three sections along the direction of motion and wherein one coil is mounted (or inserted) on the claw base of the central section and the two lateral sections of the magnetic circuit are identical.

FIGS. 5A and 5B respectively depict front and assembled views of a polyphase segmented claw pole structure wherein the mechanically assembly of the segmented armature is realized with a yoke and wherein the armature is made with three identical components (segments) based on the present invention which are regularly distributed along the direction of motion and which are magnetically isolated from each other by a magnetic air gap following a plane perpendicular to the direction of motion.

FIG. 6A and 6B respectively depict assembled and exploded views of one armature segment based on the present invention wherein the magnetic circuit is divided into three sections along the direction of motion and wherein one coil is mounted (inserted) on the claw base of the central section and the two lateral sections of the magnetic circuit are identical.

FIG. 7 is an axial sectional view in a plan that passes by the axis of rotation of a cylindrical structure made with a segmented claw pole stator with interlaced claws according to this invention and a surface mounted permanent magnet rotor split in two parts along the direction of motion, that are separated by an axial air gap.

FIG. 8 is an axial sectional view in a plan that passes by the axis of rotation of a cylindrical machine made with a segmented claw pole stator according to this invention with non-interlaced claws and with a rotor made of three rows of permanent magnets, which are separated by two axial air-gaps and mounted on the surface of a single rotor yoke.

FIG. 9 is an axial sectional view in a plan that passes by the axis of rotation of a cylindrical structure made with a segmented claw-pole stator with non-interlaced claws according to this invention and a surface mounted permanent magnet rotor split in two parts along the direction of motion, that are separated by an axial air gap and respectively equipped with two rows of permanent magnets.

FIG. 10 is an axial sectional view in a plan that passes by the axis of rotation of a cylindrical structure made with a segmented claw pole stator with interlaced claws according to this invention and a hybrid rotor split into two independent sections which are magnetically isolated by an axial air gap, following the direction of motion wherein the first section is a surface mounted permanent magnet rotor structure and the second section is a rotor made with electromagnets.

FIG. 11 is an axial sectional view in a plan that passes by the axis of rotation of a cylindrical structure made with a segmented claw pole stator with interlaced claws which is split into two magnetically isolated parts following the direction of motion, and is associated to a hybrid rotor structure.

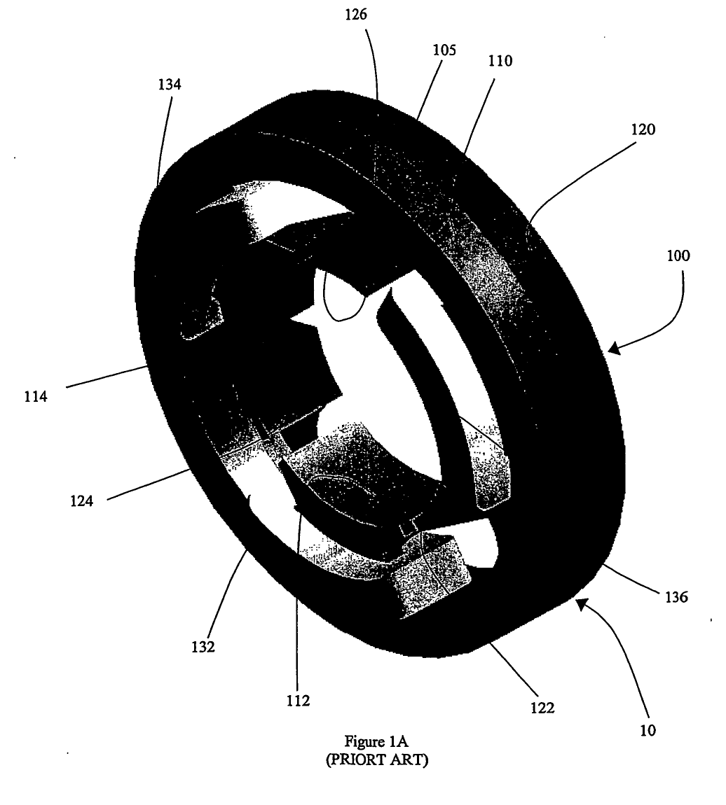

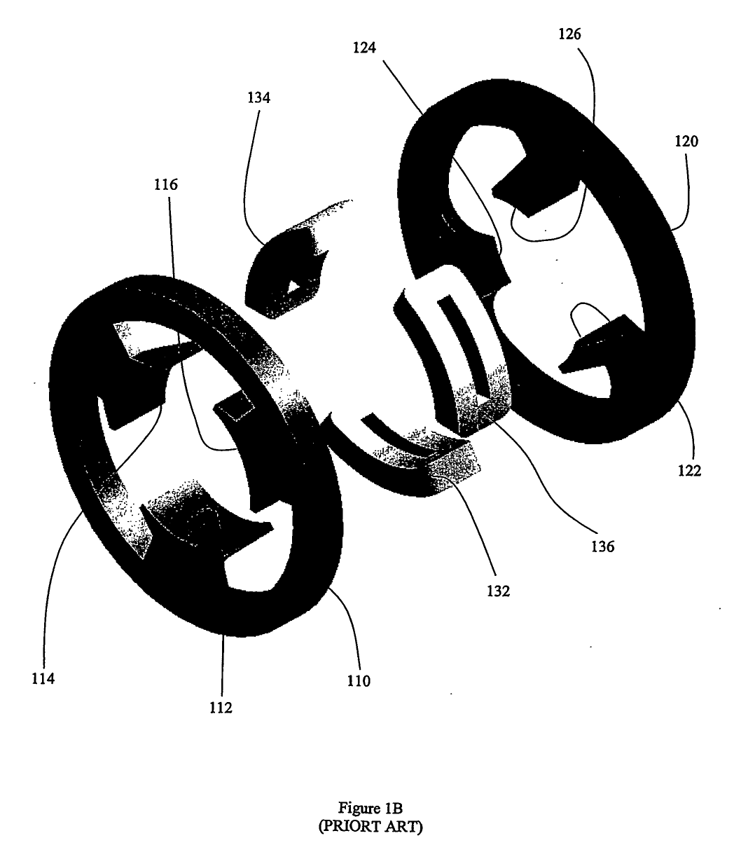

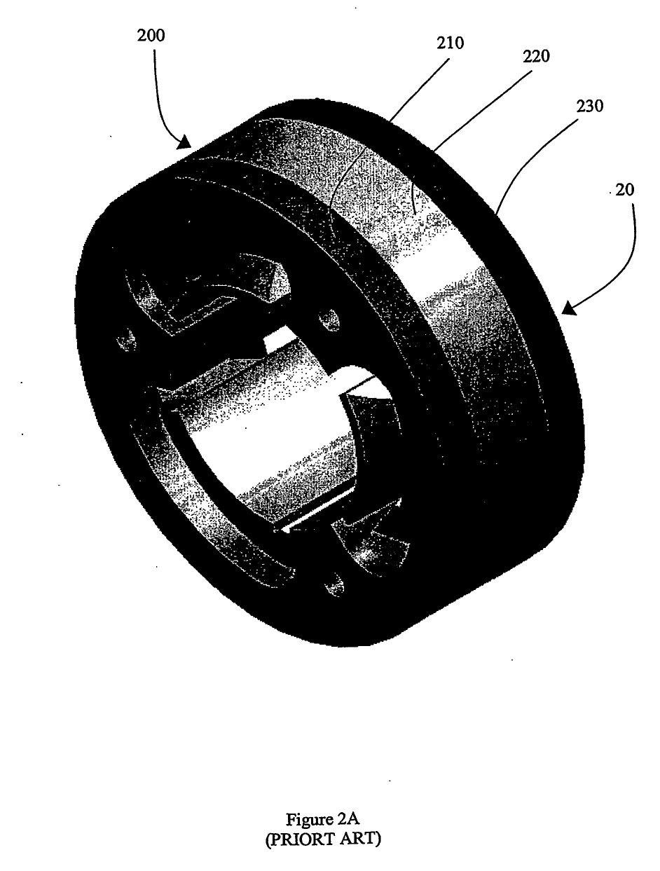

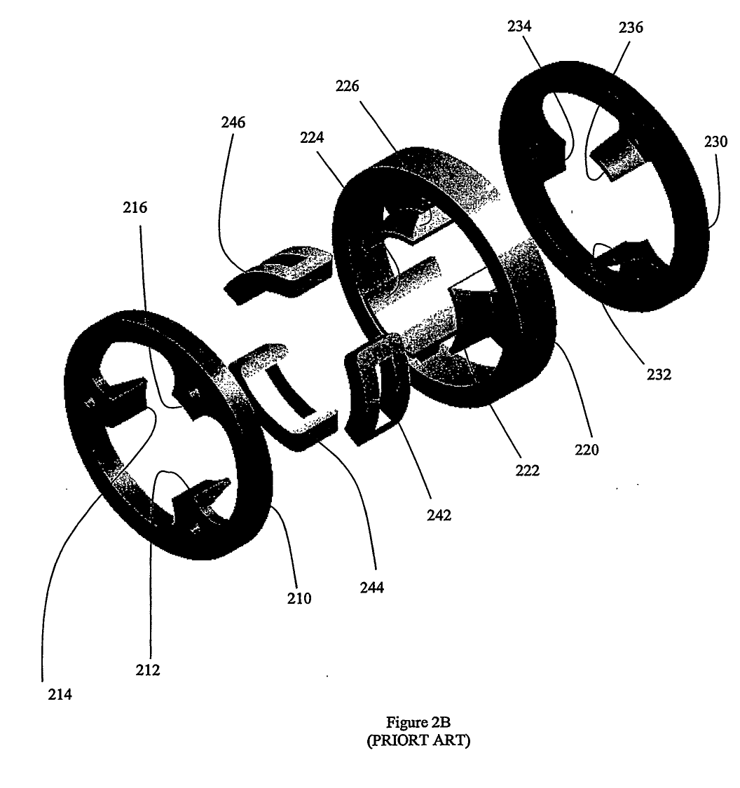

### DESCRIPTION OF THE PREFERRED EMBODIMENTS

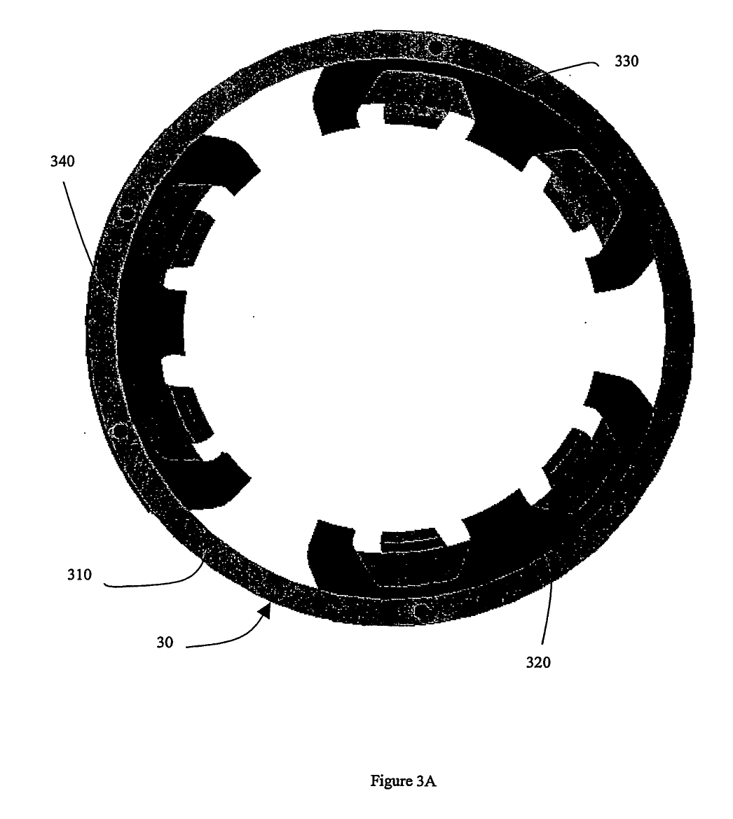

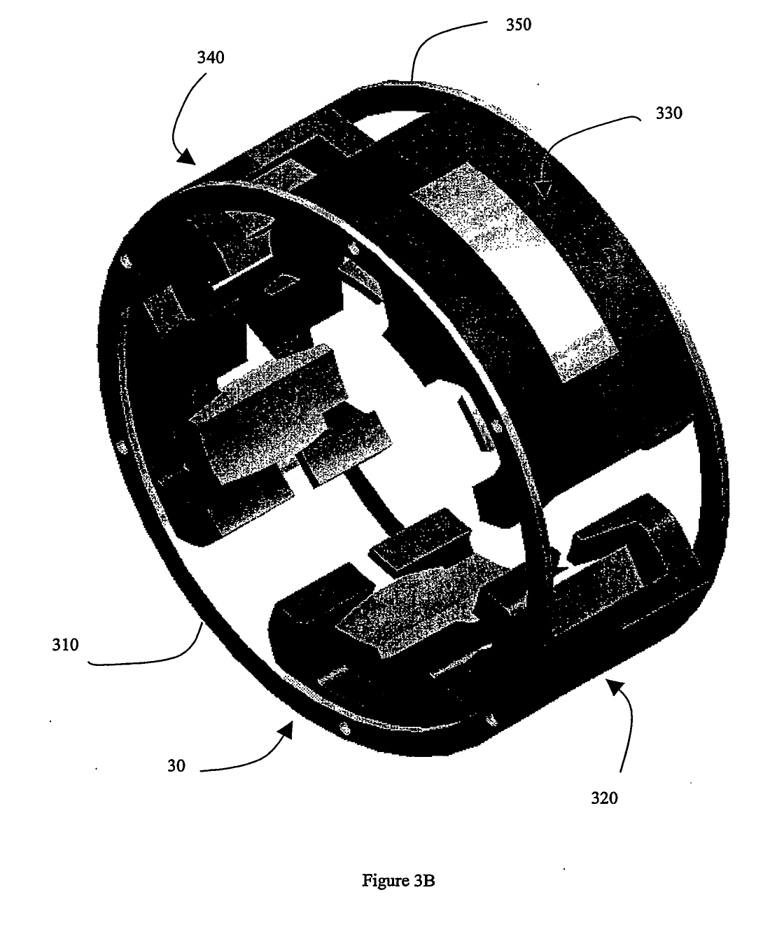

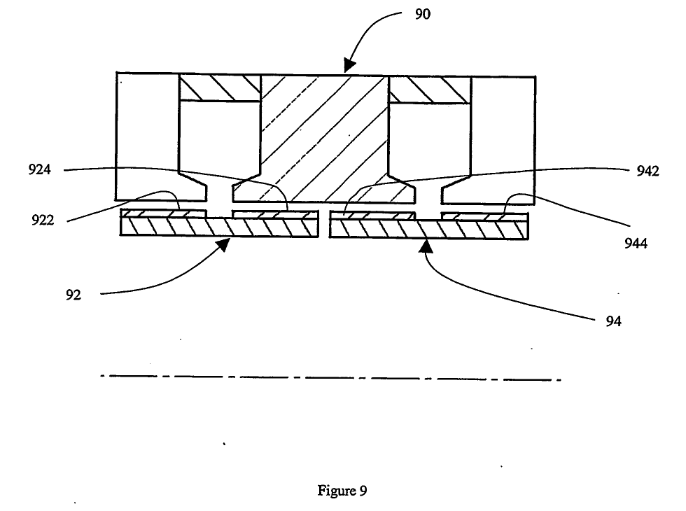

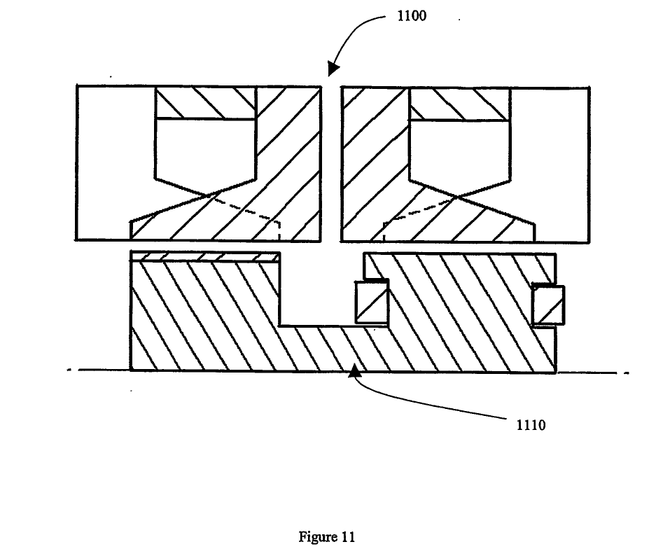

The embodiments of the present invention will be described with reference to FIGS. 3A through 11.

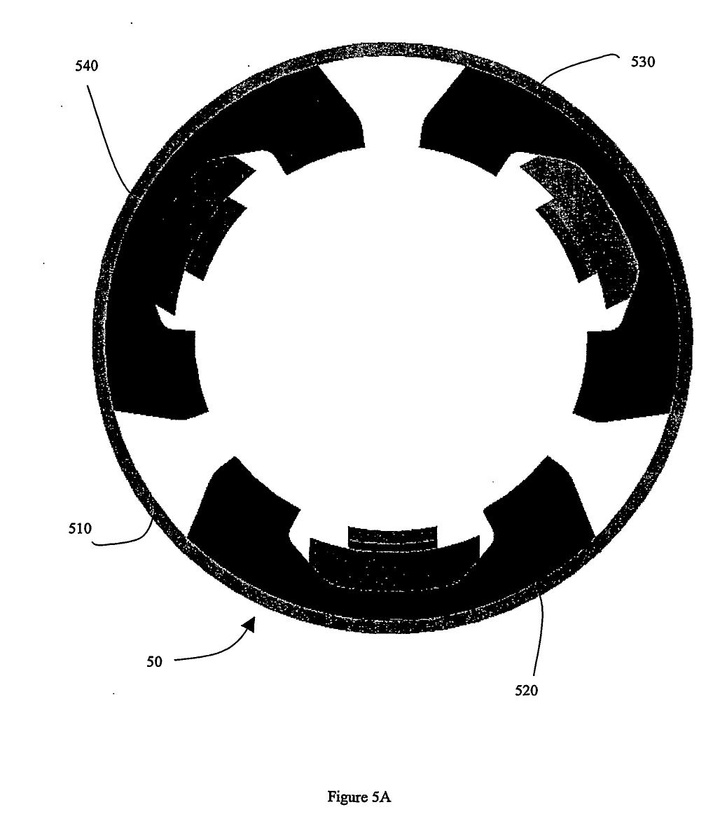

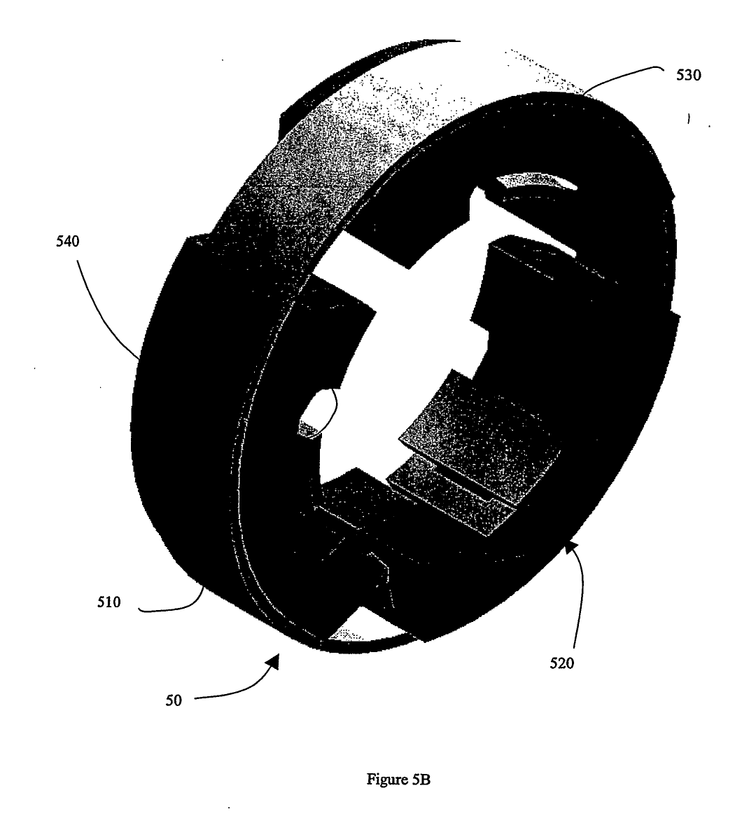

According to this invention, an electrical machine armature is realized with several identical segments that are uniformly distributed around the cylindrical air-gap surface between the stator and rotor in the case of a rotational motion, or along the planar air-gap surface between the stator and rotor in the case of a linear motion and are always separated by a magnetic air-gap surface that is in a plane perpendicular to the cylindrical air-gap surface between the stator and rotor in the case of a rotational motion as shown on FIGS. 3 and 5, or perpendicular to the planar air-gap surface between the stator and rotor in the case of a linear motion.

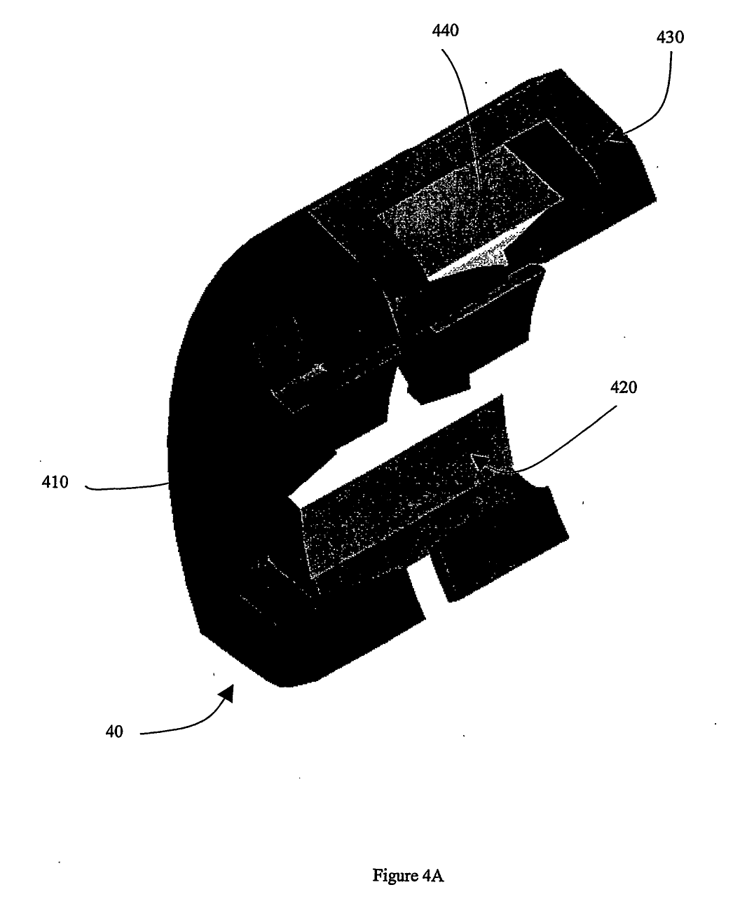

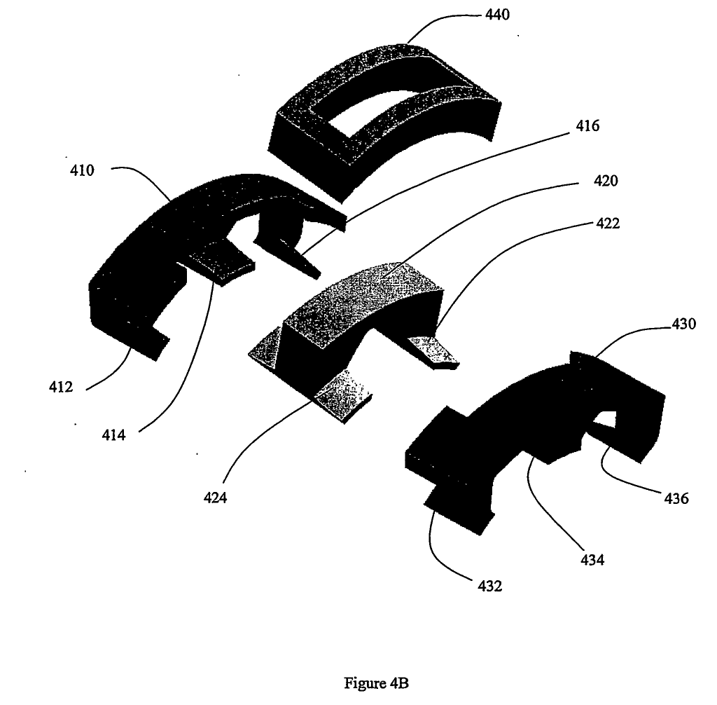

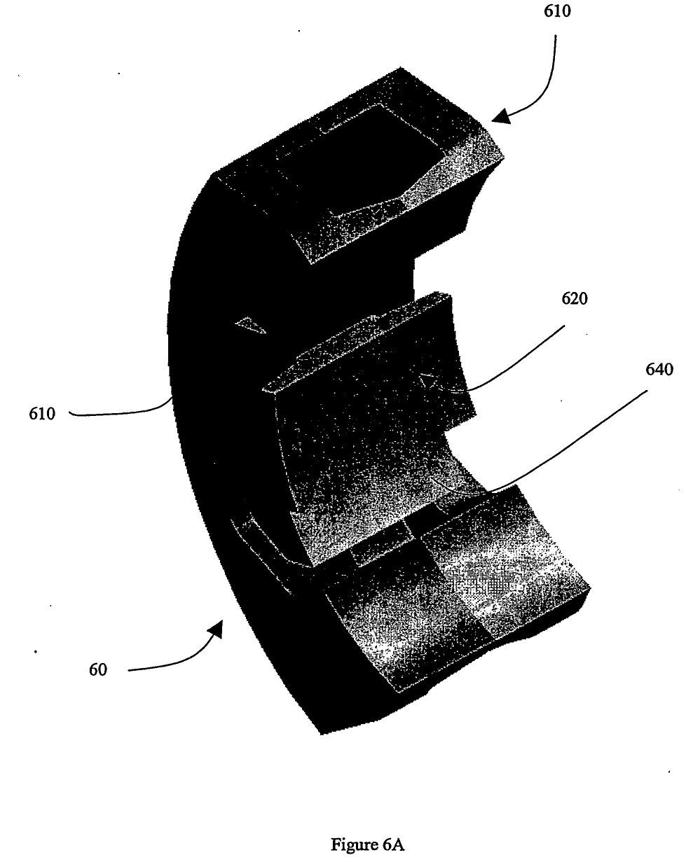

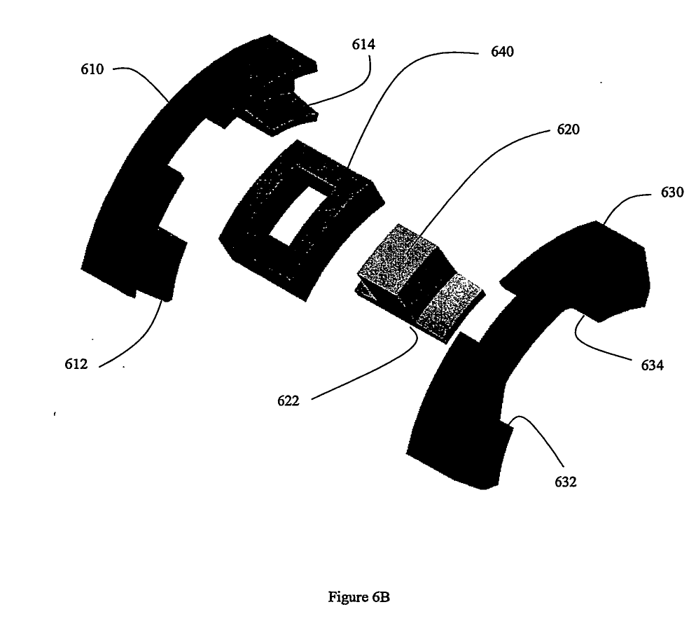

FIGS. 4A, 4B and 6A, 6B show detailed views of one armature segment according to this invention. Each segment comprises a magnetic circuit component having one or more pieces and a winding made with one or several coils (FIGS. 4A, 4B and 6A, 6B). This magnetic circuit is equipped with several rows of claws following the direction of motion and the magnetic flux circulates in the three dimensions inside them. The magnetic circuit of one armature segment is preferably made from an iron-powder based composite soft Magnetic material formed by pressing, molding, or machining. Some parts of the magnetic circuit components where the magnetic flux is circulating in two dimensions (i.e. in a plain or a bi-dimensional surface) can also be made of stacked sheets, or laminations of soft magnetic material. The mechanical assembly of the magnetic circuit components can be accomplished by gluing, screwing, or pressing the parts together or other suitable mechanical fixation processes.

The number of segments in an armature is equal to or is a multiple of the number of phases of the electrical machine. Each magnetic circuit segment can be equipped with two rows of claws only, but generally it is better to use three rows of claws, as presented in FIGS. 4A, 4B and 6A, 6B. These rows of claws are parallel one in relation to the other, and each row follows the direction of motion. The top surfaces of the claws face the air gap between the stator and the rotor. The base of a claw forms a part of the magnetic circuit that is perpendicular to the air-gap surface like a tooth in a conventional slotted machine. All the claws in an armature segment are connected to a magnetic yoke common to each row of claws (FIGS. 4A, 4B and 6A, 6B). One or several non-overlapped coils are wound around the base of certain claws. In an armature segment according to this invention, the distribution of the claws along the direction of motion can be either regular or irregular and it is possible to use various widths of claws in a same segment (see the widths of the claws 412 and 414 in FIG. 4B).

Generally, the area of the top surface of each claw, adjacent to the air-gap surface between the stator and rotor, is greater than the cross-sectional area of the base of the claw. This allows each claw to cover a larger surface of the air gap between the stator and rotor, while at the same time reducing the size of the magnetic field sources of the rotor on the other side of the air-gap surface. The axial length of the claws of each segment of magnetic circuit, along the axis perpendicular to the direction of motion is always greater than the axial length of the claw bases in the same axis as shown in FIGS. 4A, 4B and 6A, 6B. The claw can be also enlarged symmetrically on each side of the base of the claw along the axis parallel to the direction of motion. This modification assists the mechanical seating of the winding and can simplify the mounting of the coils.

Normally, the claws of two adjacent rows are interlaced, or interspaced, to minimize the total axial length of the motor, whilst still covering a greater air-gap surface (see the arrangement of claws 412, 414, and 422 in FIGS. 4A and 4B). However, when the distance between the claws becomes too small, the magnetic flux leakage between them can become significant. It is therefore preferable to reduce the axial length of the claws along the axis perpendicular to the direction of motion to minimize the flux leakages between them. In this case, the claws are not really interlaced in the axial direction along the axis perpendicular to the direction of motion but the distribution of the claw positions along the direction of motion is not modified in comparison to the previous case.

Normally, the claws of the lateral rows placed on both sides of the central row are aligned in the direction perpendicular to the rows of claws (see the arrangement of claws 412 and 432 in FIGS. 4A and 4B). Consequently their magnetic potential are identical and their axial tip along an axis perpendicular to the direction of motion can touch themselves or be separated by a small air gap without creating any magnetic flux leakage between them as shown in FIGS. 6A and 6B with claws 612, 632 and 614, 634.

As indicated above, an armature segment of the present invention can incorporate one or more wire coils, connected either in series or in parallel, to generate the magnetic field in the claws and/or to embrace the magnetic flux that is circulating. Each coil is wound directly around the base of one claw (FIGS. 6A and 6B) or it can also encircle several claws (FIGS. 4A and 4B). The coils are always regularly distributed around the cylindrical air-gap surface between the stator and rotor in the case of a rotational motion, or along the planar air-gap surface between the stator and rotor in the case of a linear motion and they are not interlaced. The axes of the coils are always perpendicular to the surface of the air-gap between the stator and rotor and the plane defined by the coils is always parallel to the direction of motion and the air-gap surface between the stator and rotor. In the case of embodiments employing a number of claw rows higher than two, the coils are mounted entirely on the bases of the even rows, or the odd rows, but not intricate or intermixed.

As explained above, the embodiments described herein generally have a cylindrical geometry for the use in a cylindrical machine armature. For convenience of reference, the direction co-linear with the axis of revolution of the structures described herein shall be referred to as the axial direction; the direction defined by a point rotating about the axis of revolution shall be referred to as the circumferential direction; and the direction normal to the axis of revolution shall be referred to as the radial direction. To simplify the description, only outer-segmented armatures of cylindrical machines are presented. However, it must be evident that the embodiments described above also can be applied to an inner armature.

FIGS. 3A and 3B show a cylindrical segmented armature 30 of an electrical machine with an internal rotor structure (which is not represented in these figures). It is a three-phase armature that is divided in three identical segments 320, 330, 340. These segments are regularly distributed around the cylindrical surface of the air gap between stator and rotor, following the direction of motion and they are separated by a magnetic air-gap in a plane perpendicular to the cylindrical air-gap surface between the stator and rotor.

The segments are mechanically assembled and correctly positioned by two annular flanges 310, 350 that are fixed on the lateral parts of the magnetic circuit of each segment.

The magnetic circuit of each segment has a number of claws (discussed below) that extend in a radially inward direction from the yoke. Each segment includes one or several coils. These coils are generally mounted on the central row of claws and there are two other rows of claws which encircle the coils and are used to channel and distribute the magnetic flux in the air gap between the stator and the rotor as presented in FIGS. 4A, 4B and 6A, 6B

Generally, the magnetic circuit of each segment can be divided into three parts, following three rows of claws (FIGS. 4B, 6B). This division is defined by a plane perpendicular to the cylindrical air-gap surface and following the direction of the motion. As shown in FIGS. 4A and 6A, a coil can be easily wound or easily mounted on the central part of the magnetic circuit. In the case of FIG. 4B, this central part 420 of the magnetic circuit has two claws 422, 424. There are two identical magnetic parts 410, 430 with three claws 412, 414, 416 and 432, 434, 436 (FIG. 4B). These identical lateral parts are mechanically connected on both sides of the yoke of the central magnetic part 420 without any magnetic air gap. This magnetic circuit arrangement encircles the coil 440 that is mounted on the central part 420 (FIGS. 4A and 4B).

In the embodiments of FIGS. 4A and 4B and 6A and 6B, a row of claws which supports a winding is adjacent to rows of claws without windings.

It is also possible to make different types of modifications to the magnetic circuit component affecting the cogging torque, such as slots or grooves with lower depths on the top surface of the claws facing the air-gap surface between the stator and rotor, or special profiling of the claws to increase in frequency of the cogging torque pulsations, thus helping to reduce its amplitude. One can also adapt the harmonic content of the emf by using rectangular, triangular, or trapezoidal shapes of claw.

It is also possible to split in the radial direction one or several claws which belong to a same row of claws of the segment, in order to define a new air gap between its parts. This split can be radially extended up to the yoke. However, in the following description, we consider that this kind of division process of the claw does not change the total number of claws in a segment because both parts of this divided claw are not interspaced by another claw placed in another row of claws of the segment. The general structural variables of a polyphase claw-pole segmented armature according to the present invention are the number of phases Mph, the number of segments Nseg, the total number of coils per segment Nb, and two specific numbers of claws G1 and G2 in each magnetic segment which are defined below. According to the present invention, these variables must satisfy the following relationships:

Mph>1

Nseg=k1×Mph k1 is an integer greater than 0;

G2=G1+1 or G2=G1−1

G2>0

Nb=k2 k2 is an integer greater than 0 but lower than G1+2;

where:
Mph is the number of phases; Mph being higher than 1;
Nseg is the total number of identical segments regularly distributed along the direction of motion;
Nb is the total number of coils distributed along the length of a row in each armature segment;
G1 is the number of claws in each armature segment, which are in a row of claws which supports the coils ;and
G2 is the number of claws in each armature segment, which are in a row of claws which does not support any coil.

In the embodiments of this invention, each armature segment has only one phase winding which can be realized with one or several coils. However, it is also possible to connect the winding of different segments in series or in parallel to realize a complete armature phase winding. The armature segments associated with each phase are distributed in the phase order around the circumference of the stator. The same sequence of segment distribution is repeated several times when a phase winding is using more than one segment. For example, in the case of a three-phase machine, with identified phases A, B, and C, the order of the coil segments is A, B, C if its segmented polyphase claw-pole armature is made with three segments. The order of the coils segments becomes A, B, C, A, B, C if the armature is made with six segments and A, B, C, A, B, C, A, B, C in the case of nine segments. The coils of each phase winding can be connected either in series or in parallel, in accordance to the specific application and design.

The polyphase claw pole segmented armature presented in FIGS. 6A and 6B preferably is associated with a rotor with 8 or 10 poles. In this example, the assembly of the three armature segments is realized with a cylindrical external yoke made of non-magnetic material. The top side of each armature segment which is in contact to the cylindrical external non-magnetic yoke can be mechanically assembled to it by gluing, screwing, or pressing techniques. It is also possible to use a massive magnetic material for the realization of the yoke presented in FIGS. 6A and 6B. In this case, the cross section of this yoke must be small enough to obtain a magnetic saturation of the material and to minimize the magnetic flux leakage between two adjacent armature segments.

As in the case of a conventional laminated motor structure, the modification of the magnetic circuit axial length is used to adapt the power of the motor by adjusting the number of identical laminations to stack. This approach has the advantage of optimizing the production process by using identical magnetic parts for the design of a large power range of motors. One can apply the same approach in the case of the claw-pole armature segments presented in this invention. By example, one can directly stack two identical armature segments along the axis of rotation, without separating them by an air gap. This transformation doubles the length of the complete segmented armature and doubles the power of the machine. The assembly of both armature segments can be realized with a common yoke or between two flanges. Optionally, a slight shift can be introduced between the two segmented structures in the direction of motion, to reduce the cogging torque, for example.

The armature segments, according to this invention, can be completely insulated by a conventional tightness method in order to let a cooling fluid circulate inside them. In this case, the winding is directly in contact with the cooling fluid and heat dissipation is improved.

Another way to improve heat dissipation is to equip each armature segment with a cooling system, using water or any kind of cooling fluid circulation, with forced or natural convection. The cooling system can be integrated as a part of the magnetic circuit. It is then possible to compact the cooling system integrated in the magnetic circuit in a single part, made with the same magnetic material. One can equip the outer surface of each segment with cooling fins to increase the surface in contact with the ambient air. These fins can form an integral part of the magnetic circuit component, where the magnetic flux can also circulate. With such an arrangement, the heat dissipation is improved, without increasing the weight, the total size and weight of the electrical machine is minimized, the power and torque-to-weight ratio are increased, and the machine production process is simplified.

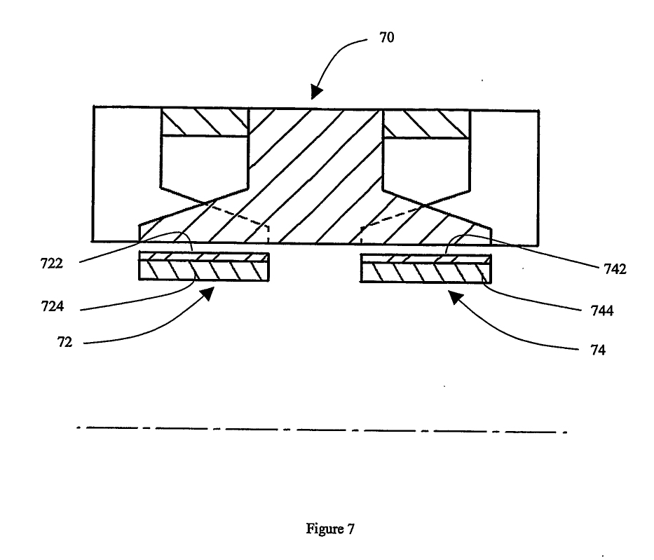

The segmented claw-pole stator armatures can be used with classic structures of cylindrical, axial, or planar rotors of synchronous machines, variable reluctance machines, and induction machines. However, in the case of an armature segment according to this invention, which is divided in three parts, following the direction of motion and with two adjacent rows of claws interlocked (or interspaced), it can be interesting to split the rotor in two parts, as in the example shown in FIG. 7. This figure shows a cross-sectional view of a segmented claw-pole armature 70 in a plan that passes by the axis of rotation of the rotor. This segmented claw-pole armature 70 is associated to a cylindrical rotor structure divided in two identical parts 72, 74 that are separated by an axial air gap. These rotor parts 72, 74 have several magnetic poles, alternatively magnetized along the direction of the rotor motion. In the example of FIG. 7, permanent magnets are mounted on the surface of annular magnetic yokes 724, 744 which can be mechanically assembled on a same shaft (not shown in this figure). Each rotor part must be correctly positioned in relation to the stator claws. In this case, the claws of the central and lateral parts can have an identical radial thickness. This division of the rotor into several rows can also be used to smooth the cogging torque if the magnet rows are slightly shifted with a suitable angle.

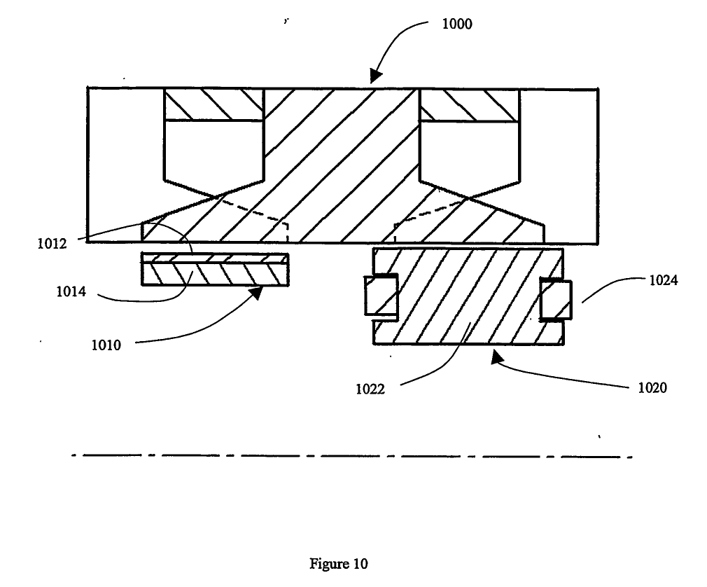

It is possible to realize a synchronous machine by using a segmented claw-pole armature, according to this invention, with a hybrid rotor excitation system: the first rotor part is equipped with permanent magnets and the second rotor part is equipped with claw or teeth and one or several coils to realize several electromagnets supplied by a direct current. An example of such a hybrid rotor is presented on FIG. 10. In such a machine, the magnetic flux produced by each rotor excitation part respectively circulates inside the magnetic circuit of the armature segments and along different flux paths if the two rotor parts 1010, 1020 are separated by an axial magnetic air gap, as shown in FIG. 10. This specific arrangement permits control of the total flux inside the coils mounted on the central part of an armature segment by using the excitation direct current of the electromagnets mounted on the second part of the rotor. Such a machine structure with a hybrid rotor associated to a segmented claw-pole armature, according to this invention, can be advantageously used for a vehicle alternator or an electrical vehicle motorization.

Different arrangements of a hybrid rotor structure can be associated to the segmented claw-pole armature presented in this invention. For example, one can realize a hybrid rotor with a first part equipped with permanent magnets and a second part equipped with a squirrel cage or wound rotor structure used in asynchronous motors. This kind of machine can be used as a line-start permanent magnet motor. By using the same approach, it is also possible to associate a segmented claw-pole armature presented in this invention to a hybrid rotor with a first part equipped with permanent magnets and a second part equipped with a variable reluctance structure. This arrangement can be interesting for traction applications where a flux weakening control is necessary for high-speed operation.

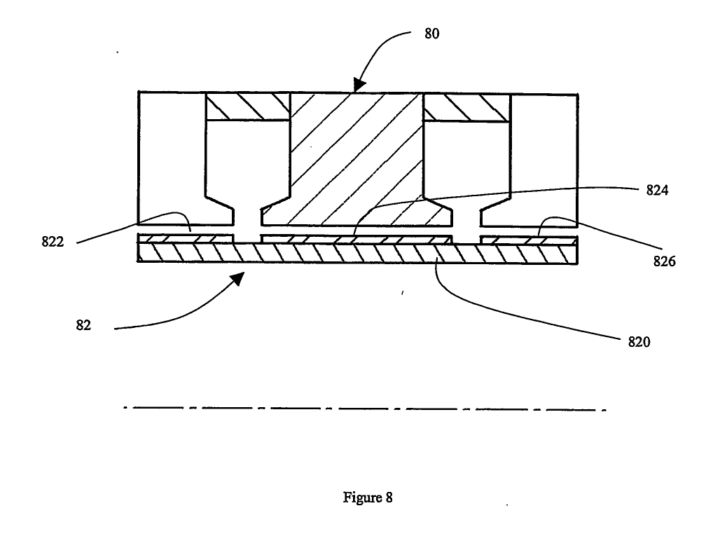

In the case of an armature segment according to this invention, which is divided in three parts, following the direction of motion and with two adjacent rows of claws non interlocked, it can be interesting to use the configuration of permanent magnet rotor presented in FIG. 8. FIG. 8 shows an axial view of a segmented claw-pole armature 80 associated to a cylindrical rotor structure 82 with a single magnetic yoke 820 and three rows of permanent magnets rows 822, 824, 826. A permanent magnet row 824 is positioned in regard to the claws of central part of the armature segment 80. The other permanent magnet rows 822, 826 are positioned in regard to the claw of the lateral parts of magnetic segments. The respective widths of these two lateral magnet rows are equal to one half of the central magnet row. It can be noticed that it is also possible to smooth the cogging torque if the three magnet rows are slightly shifted with a suitable angle.

In the case of a synchronous machine or a permanent magnet machine using a polyphase claw-pole segmented armature according to this invention, the performance of the machine depends on the selected combination of number of rotor poles pair and number of claws of the segmented armature. Higher performances are obtained when the following relationship is satisfied:

2P=Nseg×(G1+G2)+K

where:
P is the number of pole pairs on the rotor;
Nseg is the total number of identical armature segments which are regularly distributed along the direction of motion;
G1 is the number of claws in each armature segment, that are in a row of claws which supports the coils;
G2 is the number of claws in each armature segment that are in a row of claws which does not support any coil; and
K is an integer equal to −3 or −2, or −1 or 1 or 2 or 3.

The polyphase claw-pole segmented armature structures according to this invention can also be used for electrical traction and propulsion systems, electrical generation systems, robotics and machine tools, domestic appliances, mechatronic systems, rotating and linear electromechanical actuators, automotive, aeronautics and aero-space applications.

While only some embodiments of the present invention are described above, it is obvious that several modifications or simplifications are possible without departing from the spirit or the scope of the present invention.

We claim:

1. A moving or stationary armature of a polyphase electrical machine comprising a plurality of identical magnetic circuit components, the components being distributed uniformly in a direction of motion and separated by a magnetic air gap in a plane perpendicular to an air-gap surface between a stator and a rotor, the components being used for magnetic coupling to another machine part having poles alternately magnetized North-South in the direction of motion, with the other machine part being separated from the components by an air gap to allow for motion, where a circuit of each component comprises:
a plurality of claws, the claws arranged in a plurality of rows,
wherein a base of each claw in a same row is connected to a common yoke; and
one or several coils wound on a base of corresponding claws,
wherein one or several coils have an axis perpendicular to the air-gap surface.

2. An armature according to claim 1, wherein the armature has characteristics of:
Mph>1;
Nseg=k1×Mph (k1 is an integer greater than 0);
G2=G1+1 or G2=G1−1;
G2>0;
Nb=k2 (k2 is an integer greater than 0 but lower than G1+2),
wherein:
Mph is a number of phases;
Nseg is a total number of identical magnetic circuit components regularly distributed along the direction of motion;
Nb is a total number of coils distributed along a row of claws in one armature segment;
G1 is a number of claws in each magnetic circuit component, this number referring to claws in a row that are supporting the coils; and
G2 is another number of claws in each magnetic circuit component, this number referring to claws in a row that are not supporting any winding.

3. A magnetic circuit component used in an armature according to claim 1, made from a plurality of parts, each including a row of claws.

4. A magnetic circuit component according to claim 3, wherein the magnetic circuit component comprises three parts fastened together, with each part including a row of claws, and with the coils mounted on a central part, and with two opposing parts being identical.

5. A magnetic circuit component according to claim 3, wherein the magnetic circuit component is made at least in part from composite magnetic material of metal powder formed by pressing, molding, or machining.

6. A magnetic circuit component according to claim 3, wherein the magnetic circuit component is made at least in part from laminated magnetic material formed by punching or machining.

7. A magnetic circuit component according to claims 3, wherein a top surface of each claw has a rectangular, triangular, or trapezoidal shape.

8. A magnetic circuit component according to claim 3, wherein a plurality of the claws are slotted or grooved.

9. A magnetic circuit component according to claim 3, incorporating claws having surfaces adjacent the air gap, which are enlarged with respect to their base in different directions.

10. A magnetic circuit component according to claim 3, wherein bases of the claws possess rectangular, oval, or circular sections with rounded sides- or corners.

11. An electrical machine comprising a plurality of magnetic circuit components according to claim 3, wherein some components are stacked along their axes of rotation with or without a magnetic air-gap between them.

12. A magnetic circuit component according to claim 3, further including an integral cooling system made of composite magnetic materials.

13. An armature according to claim 1, wherein the armature is a stator armature associated with a rotor that is split in several parts along the direction of motion.

14. An armature according to claim 1, wherein the armature is a stator armature associated with a hybrid rotor realized with a plurality of rotor structures that are stacked along their axes of rotation with or without a magnetic air-gap between them.
